(19) United States
(12) Patent Application Publication
(10) Pub. No.: US 2013/0018822 A1
(43) Pub. Date: Jan. 17, 2013

(54) PLUSH ANIMAL MEMORIALIZATION KIT

(71) Applicant: Alane TERSHEL, Marvin, NC (US)

(72) Inventor: Alane TERSHEL, Marvin, NC (US)

(21) Appl. No.: 13/548,156

(22) Filed: Jul. 12, 2012

Related U.S. Application Data
(60) Provisional application No. 61/506,876, filed on Jul. 12, 2011.

(51) Int. Cl. A63H 3/02; G06Q 90/00

(52) U.S. Cl. 705/500; 446/369

(57) ABSTRACT

A plush animal memorialization kit includes a plush animal having wings, a certificate, a collar, and a tag. The certificate may be personalized according to information pertaining to a deceased pet. A method of marketing a plush animal includes providing a plurality of plush animal memorialization kits, each containing a plush animal resembling one of various pet types, assigning a unique identifier to each plush animal, and marketing the plush animals to pet owners as a way to memorialize or honor pets belonging to the pet owners.

### CROSS-REFERENCE TO RELATED APPLICATION

The present application is a U.S. nonprovisional patent application of, and claims priority under 35 U.S.C. §119(e) to, U.S. provisional patent application serial number 61/506,876, filed Jul. 12, 2011, which provisional patent application is incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to a plush animal kit that memorializes a deceased pet, or honors a pet.

2. Background

Plush animals are ubiquitous in toy stores and other locations. They have remained popular because, among other things, they are cute, soft, has a unique characteristic, or resembles a pet. Although traditionally sold as a standalone toy, in recent years a variety of sales methods and additional features have been utilized to encourage sales.

Some suppliers have incorporated use of the internet with the sale or use of certain plush toys. For example, there are some brands for which the buyer can register their plush online. Webkins, Ty, and Shining Star have websites to name a user's plush. In each case, however, the plush is meant to represent or correspond to a non-deceased animal, not a deceased one. Webkins, Ty and Shining Star plushes are not adapted nor are they marketed to represent a pet that is deceased or as a way to honor a pet. Instead, the websites offered by such companies have interactive games and players can earn points or “money” to purchase items for their online animal. Such websites are not known to enable the customer to personalize a certificate that can be printed and to register and name the plush animal. Furthermore, the companies mentioned above produce a variety of plush for which production is limited and then the plush is retired causing scarcity. Unfortunately, this can result in the retirement of a plush style that most closely resembles a particular owner's pet.

Build a Bear retails stores offer a certificate or story book that is filled out at the store. However, Build a Bear plushes are likewise neither adapted nor marketed to represent a pet that is deceased or as a way to honor a pet. For example, Build a Bear's certificate does not offer a specific way to memorialize the plush, and the certificate does not provide a “in memory” or “in honor”, space for an epitaph, or a space to insert a picture of a loved pet.

Although a connection between stuffed animals and live animals has presumably been made by many people, conventional plush animals and conventional sales techniques have not traditionally been utilized to create connections between plush animals and deceased animals, such as pets. More particularly, although known sales techniques may result in the sale and use of plush animals to represent a deceased pet or other animal, thereby memorializing such animal, a need exists for more direct and adaptable sales techniques to supply specialized plush animals or animal kits to aid pet owners in the grieving process after the death of a loved pet and to memorialize those pets.

### SUMMARY OF THE PRESENT INVENTION

In at least one aspect of the present invention, plush animals are marketed to pet owners as memorializations of such owners' deceased pets. The plush animals may be cute, soft, resemble to the pets, and include other unique characteristics corresponding to the pets. The plush animals may be provided in kit form, including, for example, a collar that can be personalized and a certificate. The purchaser may be provided with the ability to register and name the plush, the ability to memorialize a loved pet, and the ability to personalize the certificate with a photo of a pet.

Broadly defined, the present invention according to one aspect is a plush animal memorialization kit, including: a plush animal having wings; a certificate; a collar; and a tag. The certificate may be personalized according to information pertaining to a deceased pet.

Broadly defined, the present invention according to another aspect is a plush animal memorialization kit, including: a plush animal having wings; a collar; a tag containing a unique serial number; and a linkage between the unique serial number and a software system. The software system may be utilized to print a certificate with personalized information about a deceased pet.

Broadly defined, the present invention according to another aspect is a method of marketing a plush animal, including: providing a plurality of plush animal memorialization kits, each containing a plush animal resembling one of various pet types; assigning a unique identifier to each plush animal; marketing the plush animals to pet owners as a way to memorialize or honor pets belonging to the pet owners.

In a feature of this aspect, each plush animal has wings.

In another feature of this aspect, each plush animal has a tag. In a further feature, the tag includes the unique identifier.

In another feature of this aspect, each plush animal memorialization kit includes a certificate.

In another feature of this aspect, the method further includes a step of receiving, from a pet owner, input representative of the identifier for a particular plush animal purchase by the pet owner. In a further feature, the method further includes a step of comparing the input received from the pet owner to a database of known identifiers to identify a match. In a still further feature, the method further includes a step of providing, in response to a match being identified, a notice of registration to the user; and/or the method further includes a step of printing a certificate with personalized information about a deceased pet in response to a match being identified.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is an exemplary plush animal memorialization kit in accordance with a preferred embodiment of the present invention;

FIG. 2 is posterior view of the exemplary plush animal of FIG. 1;

FIG. 3 is a side view of the exemplary plush animal of FIG. 2;

FIG. 4 is a front view of the certificate of the kit of FIG. 1;

FIG. 5 is a side view of the collar of the kit of FIG. 1;

FIG. 6 is a front view of an exemplary label on the plush animal of FIG. 2;

FIG. 7 is a side view of the tag, of the kit of FIG. 1, shown in a folded state; and

FIG. 8 is a front view of the tag of FIG. 7, shown in an open or unfolded state.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiments is merely exemplary in nature and is in no way intended to limit the invention, its implementations, or uses.

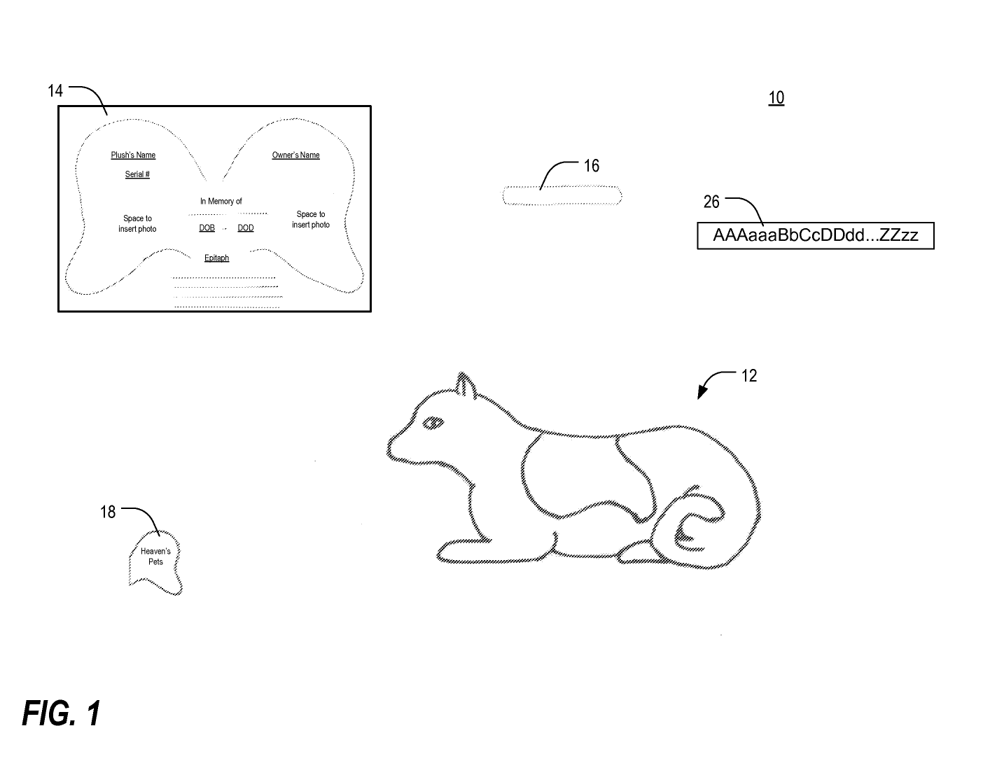

FIG. 1 is an exemplary plush animal memorialization kit 10 in accordance with a preferred embodiment of the present invention. As shown therein, the kit 10 preferably includes a plush animal 12, a certificate 14, a collar 16 (preferably with a Velcro® fastener 24), adhesive letters 26 and a tag 18, each of which is described in greater detail hereinbelow.

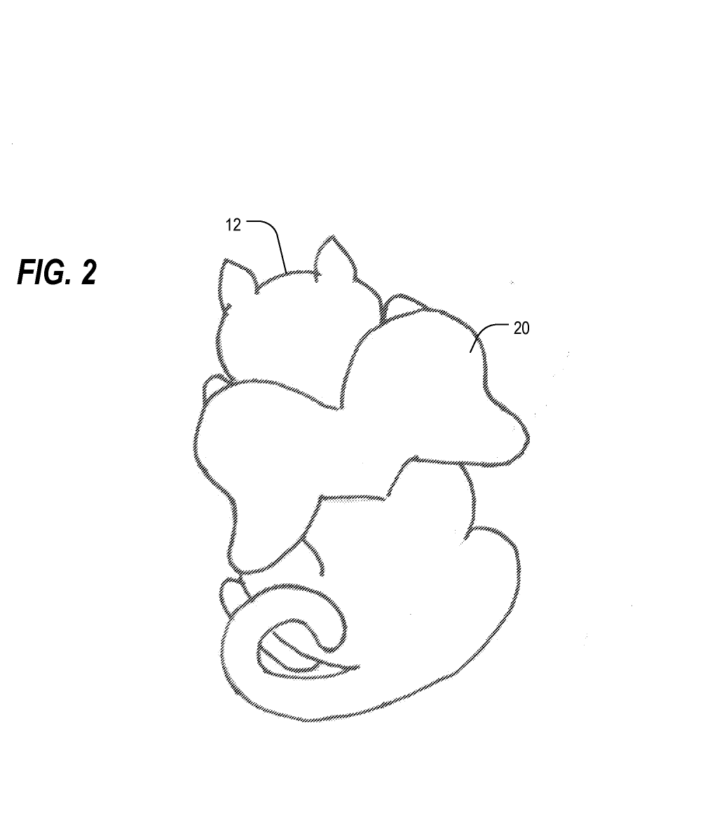

The centerpiece of the plush animal memorialization kit 10 is a plush animal 12 with soft plush angel wings. FIG. 2 is posterior view of the exemplary plush animal 12 of FIG. 1. As shown therein, the plush animal 12, which generally may be of any conventional type, includes a pair of plush wings 20 in position on the back of the animal 12 in the shoulder blade region.

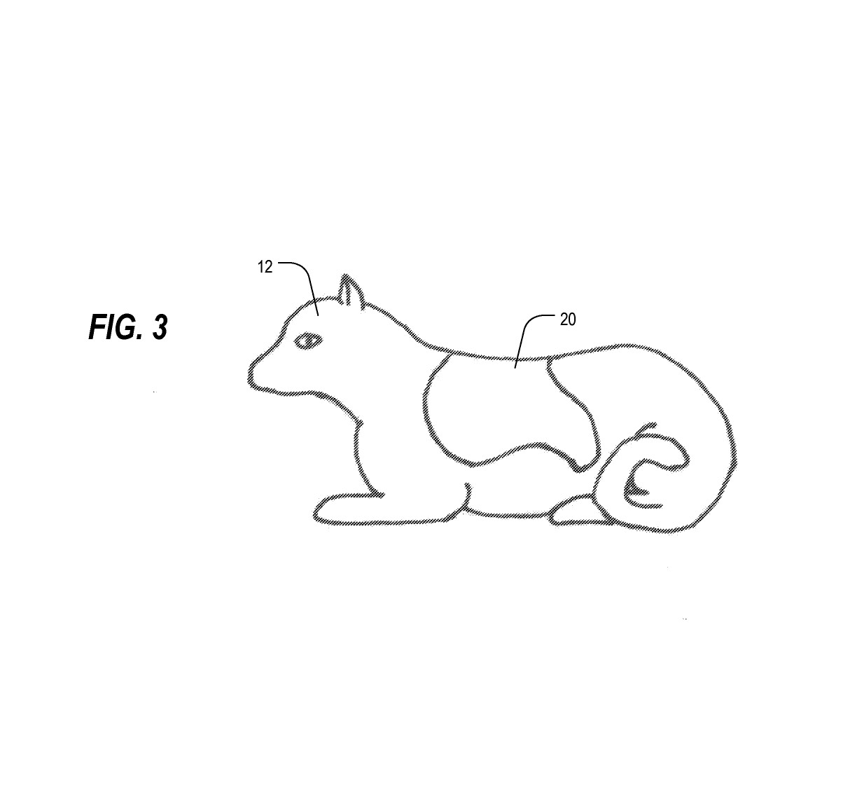

FIG. 3 is a side view of the exemplary plush animal 12 of FIG. 2. This is a lateral view of the wings 20 of the kit 10 of FIG. 1 showing their position.

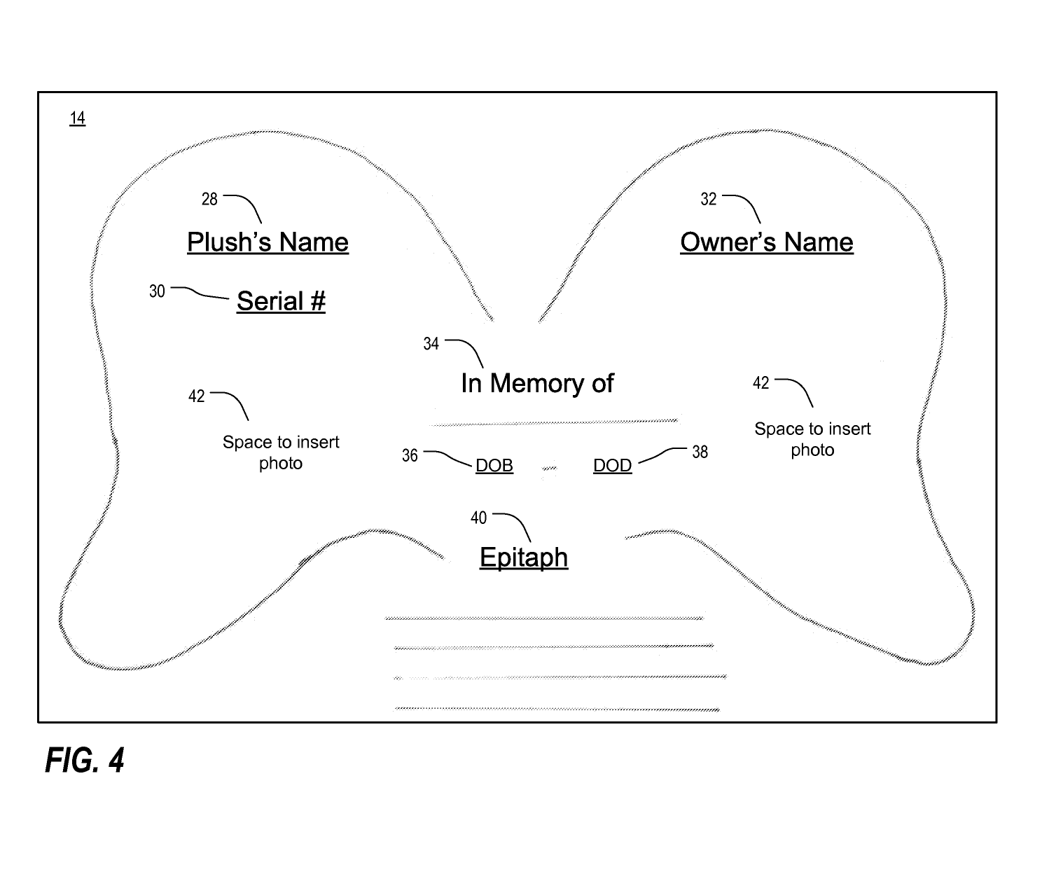

FIG. 4 is a front view of the certificate 14 of the kit 10 of FIG. 1. The certificate 14 will preferably contain the following information: name given to the plush 28, a unique identifier 30 for the plush 28, owner's name 32, name of the pet or other animal the plush is memorializing 34, the date of birth 36 of the pet (if known), the date of death 38 of the pet and a brief epitaph 40 (optional). In at least some embodiments, the identifier 30 may be a code or serial number. The certificate 14 may also provide the ability to insert a picture 42 of their pet. The background of the certificate 14 will preferably include a shadow or faint outline of the wings 20 of FIG. 2.

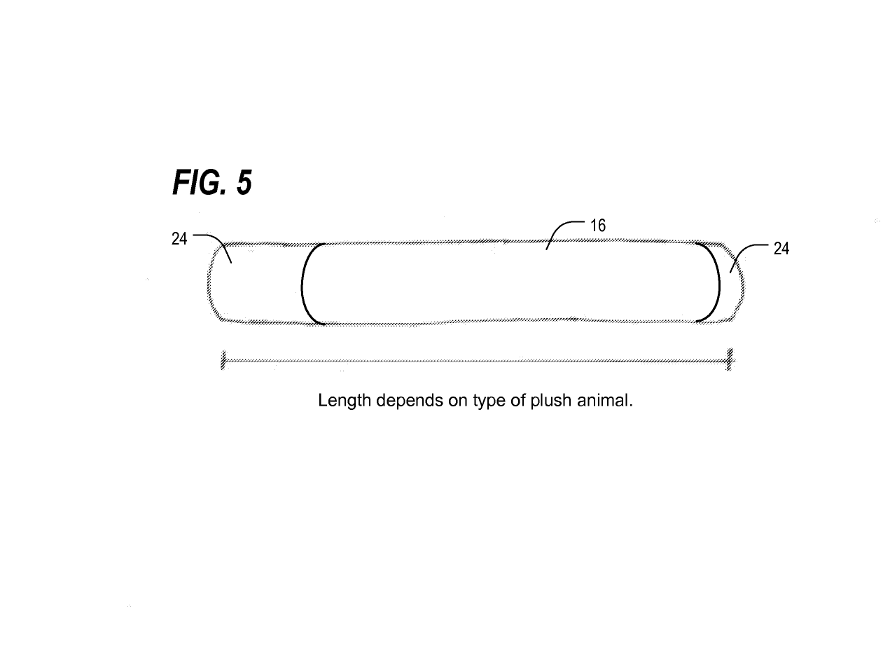

FIG. 5 is a side view of the collar 16 and adhesive letters 26 of the kit 10 of FIG. 1. The collars 16 fasten, preferably using mating Velcro® sections 24, and will come in specific sizes depending on the type of animal embodied or represented by the plush. The collars 16 may be made of a felt-like fabric material that adhesive letters 26 can adhere to easily. Velcro provides a softer surface and eliminates any hard or pointed parts. Collars 16 will be offered in a variety of colors and preferably come with adhesive letters 26. In at least one contemplated commercial embodiment, customers would choose from collars 16 that are labeled for the type of plush 12 being purchased. The width of the collars 16 will depend on the type of plush 12 so that collars 16 are proportionate to the size of the plush 12. Collars 16 may be packaged separately to enable the buyer to choose the color. The purchase of the plush 12 may include the collar 16.

FIG. 6 is a front view of an exemplary label 22 on the plush animal 12 of FIG. 2. The plush animal's label 22 preferably has the wings 20 across it and may have a brand name, such as “Heaven's Pets,” inside the wings 20.

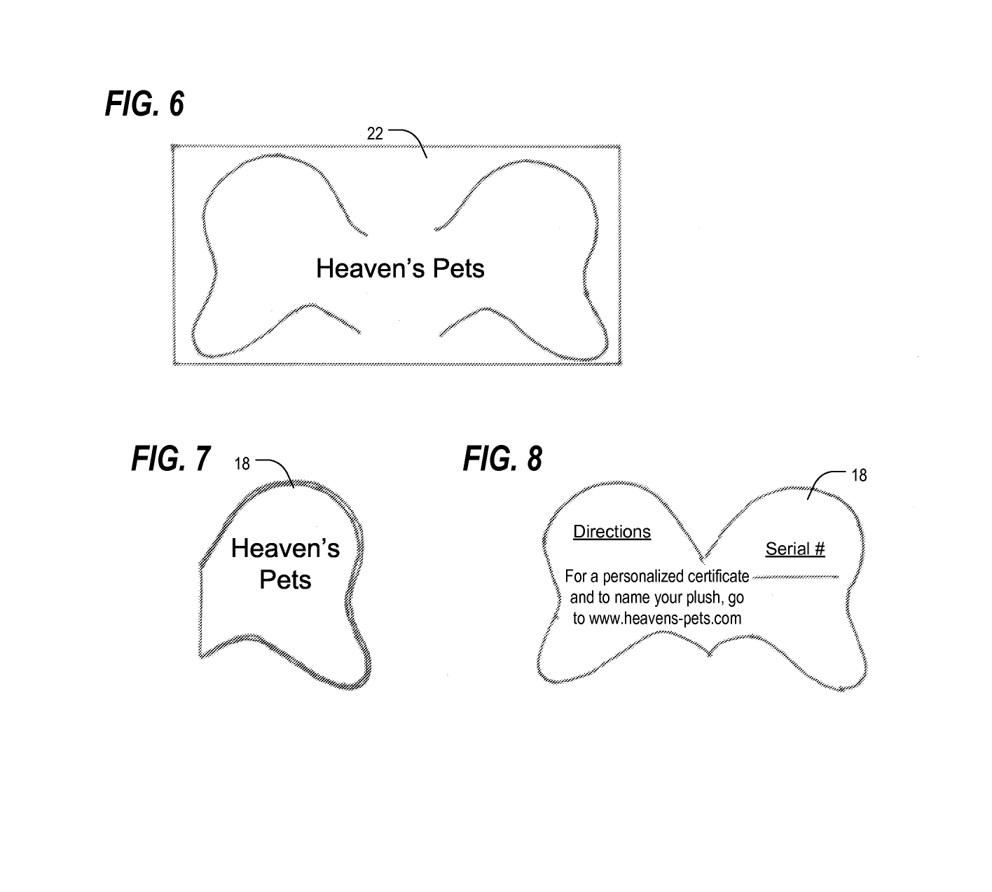

FIG. 7 is a side view of the tag 18 of the kit 10 of FIG. 1, shown in a folded state, and FIG. 8 is a front view of the tag 18 of FIG. 7, shown in an open or unfolded state. The tag 18 of the kit 10 of FIG. 1 will preferably be in the shape of the wings 20 of FIG. 2 such that the tag 18 will fold down the center when closed so as to resemble one wing 20 of FIG. 2. The inside of the tag 18 preferably contains the web site URL and other information needed to complete the certificate 14 of the kit 10 FIG. 1.

The plush kit 10 will be marketed as a memorabilia for a loved pet. The buyer can go online to a specified website such as www.heavens-pets.com to name and register the plush animal “in memory” or “in honor” of a loved pet. The buyer will be able to add a personal message (epitaph) pertaining to their pet. Each plush animal may be registered with the website and software system using the unique identifier 30 described previously. Certificates can be printed from home with the personalized information and the opportunity to insert a picture of their memorialized or honored pet. Also available would be collars 16. The collars 16 would come in a variety of colors and have adhesive letters 26 so that the pet's name can be put on the collar 16. The animals are preferably provided in a variety of colors and fur lengths. Where applicable, popular breeds would be made. For example, plushes 12 resembling various popular dog breeds are preferably made available. Most breeds of cats can be covered by using different fur lengths, colors and combination of colors. The plush animal memorialization kit 10 is not be limited to cats and dogs, however, but may be implemented with regard to a variety of animals that are kept as pets.

In preferred marketing methods, the kit 10 may be marketed as a memorabilia of a beloved pet and as a way to honor a pet. Pets have long been considered a member of the family. Each has their own personality that contributes to the dynamics of the family. Providing a memorialization of a loved pet, and particularly one that can be held, provides comfort. The kit 10 can also help provide closure for a person grieving for a lost pet. Young and old love plush animals. The plush animal memorialization kit 10 will provide comfort and a sense of peace that their pet is remembered with an original plush animal. The identifier 30 on the pet provides originality along with the certificate 14 that is personalized by the buyer.

These plush animals can be sold in a variety of retailers, including specialty toy stores, large chain stores, pet supply stores, pet specialty stores, veterinarian offices, groomers, kennels, pet daycare, dog walkers, pet sitters, ecommerce and online stores. Specialty toy stores and large chain stores can display the plush kit 10 in the same section as other plushes. Filling out the certificate 14 is optional and the kit 10 will appeal to kids even if their pet is not deceased or if they do not have a pet. Pet supply stores and pet specialty stores have sections dedicated to pet memorabilia. Groomers, kennels, and pet daycare facilities can offer the kits as gifts or have a display for purchase. Dog walkers and pet sitting companies can offer the kit as a gift to costumers. Veterinarian offices can offer the kit 10 as a remembrance gift or have a display for purchase. Other options can be hospital gift shops. A child confined to a hospital can find comfort in a plush that resembles their pet as a “guardian angel” watching over them. The plush animal memorialization kit 10 will offer a “in honor” certificate for such situations. E-commerce and/or online stores would include everything involved in the process of buying, selling, marketing and payment of the plush animal memorialization kit. This would include companies that have added an online site to a traditional bricks-and-mortar business or an on-line-only business. The ability to purchase the plush animal memorialization kit through the internet would increase the availability to consumers and retailers mentioned above, and would make it easier for friends and relatives to purchase the kit as a gift. Presenting the plush animal memorialization kit online would offer the consumer the ability to view all animals and breeds that can be bought. Retail stores are limited to popular kits sold and which animals and breeds are in the next shipment. When placing an order online, if a specific plush animal memorialization kit is not available, the consumer can request to be emailed when the kit is available or the order can be placed on backorder. Online shopping provides the consumer the ability to shop any time of the day or night. Links to the plush animal memorialization kits could appear in searches involving toys, plush animals, pets, pet memorial, kits or any word or combination of words that can be related to the plush animal memorialization kit.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof

What is claimed is:

1. A plush animal memorialization kit, comprising:
a plush animal having wings;
a certificate;
a collar; and
a tag;
wherein the certificate may be personalized according to information pertaining to a deceased pet.

2. A plush animal memorialization kit, comprising:
a plush animal having wings;
a collar;
a tag containing a unique serial number; and
a linkage between the unique serial number and a software system;
wherein the software system may be utilized to print a certificate with personalized information about a deceased pet.

3. A method of marketing a plush animal, comprising:
providing a plurality of plush animal memorialization kits, each containing a plush animal resembling one of various pet types;
assigning a unique identifier to each plush animal;
marketing the plush animals to pet owners as a way to memorialize or honor pets belonging to the pet owners.

4. The method of claim 3, wherein each plush animal has wings.

5. The method of claim 3, wherein each plush animal has a tag.

6. The method of claim 5, wherein the tag includes the unique identifier.

7. The method of claim 3, wherein each plush animal memorialization kit includes a certificate.

8. The method of claim 3, further comprising a step of receiving, from a pet owner, input representative of the identifier for a particular plush animal purchase by the pet owner.

9. The method of claim 8, further comprising a step of comparing the input received from the pet owner to a database of known identifiers to identify a match.

10. The method of claim 9, further comprising a step of providing, in response to a match being identified, a notice of registration to the user.

11. The method of claim 9, further comprising a step of printing a certificate with personalized information about a deceased pet in response to a match being identified.
